(19) United States
(12) Patent Application Publication
(10) Pub. No.: US 2010/0085275 A1
(43) Pub. Date: Apr. 8, 2010

(54) DEVICE SELECTION CONTROL APPARATUS

(76) Inventors: Satoshi Inami, Osaka (JP); Yasuhiro Tsuchida, Osaka (JP); Hideaki Yajima, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/598,621

(22) PCT Filed: Feb. 27, 2009
(86) PCT No.: PCT/JP2009/000896

§ 371 Date: Nov. 3, 2009

(30) Foreign Application Priority Data
Mar. 5, 2008 (JP) 2008-054429

(51) Int. Cl. G09G 5/00

(52) U.S. Cl. 345/2.3

(57) ABSTRACT

Provided is a device selection control apparatus for selecting a specific target device for control from among a plurality of candidate devices. A device center position detection section (14) detects position information of the candidate devices detected by the device detection section (12), and sets an allowable shake threshold value of the candidate device based on the initially detected position information. A determination section (16) acquires a shake amount of the candidate device by using the latest position information received from the device center position detection section (14), and the initially detected position information, and determines to switch to zoom processing on the picture information when the shake amount exceeds an allowable shake threshold value. A picture processing section (18) performs the zoom processing on the picture information when the determination section (16) determines to switch to the zoom processing. A display data generation section (19) acquires the picture information from the picture processing section (18) and generates display data.

### TECHNICAL FIELD

The present invention relates to a device selection control apparatus for remote-controlling other devices, and more specifically to a device selection control apparatus for selecting a specific target device for a remote control, from among a plurality of candidate devices for control.

### BACKGROUND ART

As a conventional apparatus for remote-controlling other devices, an apparatus is disclosed which shoots through a camera a picture of the candidate devices in order to identify a specific target device for control by using visible identification data that the candidate devices have, thereby establishing a network connection with the identified target device (see Patent Document 1, for example).

In addition, in the case where the plurality of candidate devices are located far away from a camera, or densely located, so that the plurality of candidate devices are displayed close together on a picture shot by a camera, an apparatus which displays the candidate devices in an enlarged manner by performing zoom processing on a picture shot by a camera (see Patent Document 2, for example), and an apparatus which automatically shifts the focus to a candidate device located close to the center of an image (see Patent Document 3, for example) are disclosed as apparatuses which allow a specific target device to be easily selected from among a plurality of candidate devices.
Patent Document 1: Japanese Laid-Open Patent Publication No. 2001-142825
Patent Document 2: Japanese Laid-Open Patent Publication No. 2005-025170
Patent Document 3: Japanese Laid-Open Patent Publication No. 2005-122422

### DISCLOSURE OF THE INVENTION

### Problems to be Solved by the Invention

However, the conventional apparatus disclosed in Patent Document 1 has a problem that it is difficult to select the specific target device without error from among the plurality of candidate devices when the plurality of candidate devices are displayed close together on the picture shot by the camera. In addition, the conventional apparatus disclosed in Patent Document 2 has a problem that it is difficult to select the specific target device without error because when the picture shot by the camera is displayed on a screen and the zoom processing is performed on the picture displayed on the screen, the higher the zoom factor of the zoom processing on the picture is, the greater the picture blurs due to hand movement. In such a situation, even when a smooth picture with less blur can be obtained by using a shake compensation technique for compensating for a blur in the picture by performing image processing, there remains a problem that a shake by a slight hand movement is processed as a large movement on the display screen, which causes a focused candidate device to be frequently switched thereamong. In addition, the conventional apparatus disclosed in Patent Document 3 also has a similar problem to that in Patent Document 2.

Therefore, in order to solve the above-described conventional problems, an object of the present invention is to provide a device selection control apparatus which reduces errors in operation when selecting a specific target device from among a plurality of candidate devices by controlling timing of performing zoom processing in the case where the plurality of candidate devices are positioned far away, or densely located.

### Solution to the Problems

The present invention is aimed at a device selection control apparatus for selecting a specific target device for control from among a plurality of candidate devices for control. In order to achieve the above-mentioned object, the device selection control apparatus of the present invention includes: an information acquisition section that acquires information including picture information which is obtained by shooting a picture of the candidate devices, and a device identifier which identifies each of the candidate devices; a device detection section that detects at least one candidate device based on the information that has been acquired by the information acquisition section; a device center position detection section that detects position information of the candidate device detected by the device detection section, and sets, based on the position information initially detected, an allowable shake threshold value of the candidate device; a device center position storage section that stores the position information initially detected by the device center position detection section; an allowable shake threshold value storage section that stores the allowable shake threshold value set by the device center position detection section; a determination section that acquires a shake amount of the candidate device by using latest position information received from the center position detection section and the position information initially detected and stored in the device center position storage section, and determines to switch to zoom processing on the picture information when the shake amount exceeds the allowable shake threshold value; a picture processing section that performs the zoom processing on the picture information when the determination section determines to switch to the zoom processing; and a display data generation section that acquires the picture information from the picture processing section, and generates display data.

Preferably, when distances between a specific candidate device and other candidate devices among the plurality of candidate devices are defined as inter-device distances, the device center position detection section selects a minimum inter-device distance from the inter-device distances, and sets half the minimum inter-device distance as the allowable shake threshold value of the specific device.

The device selection control apparatus may further include: a device information database that stores device information including a device identifier capable of identifying the candidate device. In this case the device detection section acquires the device information stored in the device information database by using the device identifier acquired from the information acquisition section, and specifies a position of the candidate device.

When detecting that the shake amount exceeds the allowable shake threshold value a predetermined number of times, the determination section may determine to switch to the zoom processing on the picture information.

Further, the device selection control apparatus may further include a control target determination section that excludes, based on collaboration information that specifies a device performing a collaborative operation with the candidate device, a slave candidate device from the candidate devices detected by the device detection section. In the case where the collaboration information is included in the information acquired by the information acquisition section, the control target determination section acquires the collaboration information from the information acquisition section via the information detection section. In addition, in the case where the collaboration information is included in the device information stored in the device information database, the control target determination section acquires the collaboration information from the device information database.

### Effect of the Invention

As described above, the device selection control apparatus of the present invention is capable of controlling the timing of performing zoom processing based on a shake amount on a picture of candidate devices being shot in real time when a specific target device for control is to be selected from among a plurality of candidate devices, thereby reducing errors in the operation when selecting the specific target device.

### BRIEF DESCRIPTION OF THE DRAWINGS

FIG. 1 is a block diagram illustrating an exemplary configuration of a device selection control apparatus 1 according to a first embodiment of the present invention.

FIG. 2 illustrates an example of data stored in an inter-device distance storage section 23 according to the first embodiment of the present invention.

FIG. 3 illustrates an example of data stored in a device center position storage section 24 according to the first embodiment of the present invention.

FIG. 4 illustrates an example of data stored in an allowable shake threshold value storage section 25 according to the first embodiment of the present invention.

FIG. 5 illustrates an example of device information stored in a device information database 13 according to the first embodiment of the present invention.

FIG. 6 illustrates an exemplary layout of candidate devices used in the first embodiment of the present invention.

FIG. 7 is a diagram illustrating a processing image of determining respective shake amounts of latest center positions according to the first embodiment of the present invention.

FIG. 8 illustrates an exemplary layout of the candidate devices used in the first embodiment of the present invention.

FIG. 9 is a flowchart illustrating an example of an operation when the device selection control apparatus 1 according to the first embodiment of the present invention selects a target device.

FIG. 10 is a diagram illustrating a display image on a display when a selection operation according to an embodiment of the present invention is performed.

FIG. 11 is a block diagram illustrating an exemplary configuration of a device selection control apparatus 2 according to a second embodiment of the present invention.

FIG. 12 illustrates an example of device information stored in a device information database 27 according to the second embodiment of the present invention.

FIG. 13 is a diagram illustrating a processing image when candidate devices used in the second embodiment of the present invention collaborate with each other.

### DESCRIPTION OF THE REFERENCE CHARACTERS

10 information acquisition section

11 control section

12 device detection section

13 device information database

14 device center position detection section

15 device information storage section

16 determination section

17 state information storage section

18 picture processing section

19 display data generation section

20 display section

21 input section

22 output section

23 inter-device distance storage section

24 device center position storage section

25 allowable shake threshold value storage section

26 device detection section

27 device information database

28 control target determination section

### BEST MODE FOR CARRYING OUT THE INVENTION

Respective embodiments of the present invention will be described below with reference to drawings.

### First Embodiment

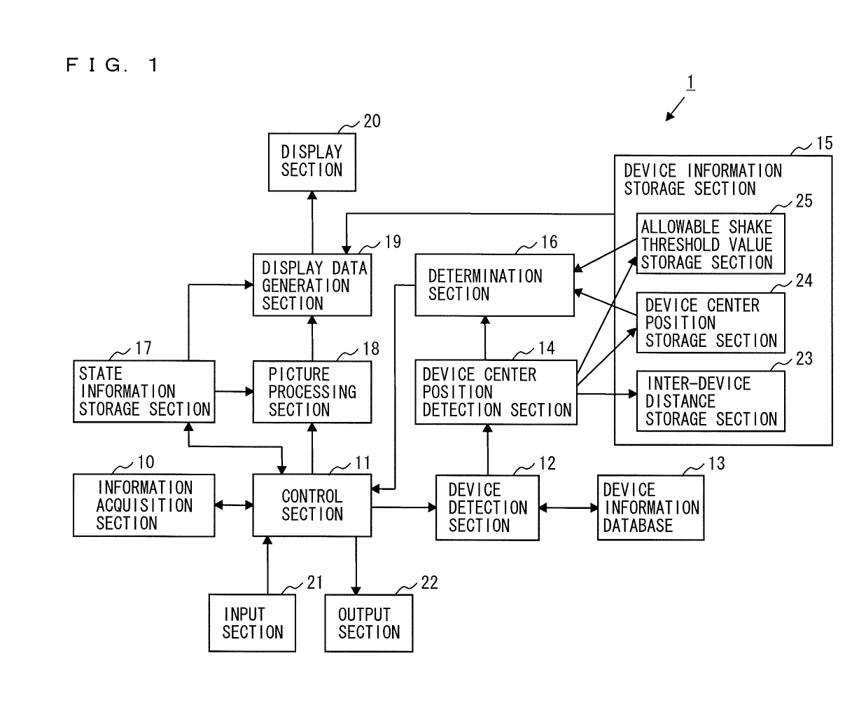

FIG. 1 is a block diagram illustrating an exemplary configuration of a device selection control apparatus 1 according to a first embodiment of the present invention. In FIG. 1, the device selection control apparatus 1 has a function (remote control function) to remote-control a target device for control and a function (picture acquisition function) to acquire a picture of the surroundings used when the target device is to be selected. The device selection control apparatus 1 may be a mobile device, such as a mobile telephone, a personal digital assistance or the like, which is connectable to a network. In this case, the device selection control apparatus 1 may remote-control the target device by, for example, installing an application. Further, involved as the target device are: audio-video equipment such as a TV set, a video, a music player, and a DVD player; household electrical appliances such as an air conditioner and an electrical light; and communication equipment such as a facsimile apparatus.

In FIG. 1, the device selection control apparatus 1 includes a control section 11, a device detection section 12, a device information database 13, a device center position detection section 14, a device information storage section 15, a determination section 16, a state information storage section 17, a picture processing section 18, a display data generation section 19, a display section 20, an input section 21, and an output section 22. Further, the device information storage section 15 includes an inter-device distance storage section 23, a device center position storage section 24, and an allowable shake threshold value storage section 25. The device selection control apparatus 1 need not include the input section 21, the output section 22, the display section 20, and the device information storage section 15 inside thereof, but may use a configuration outside thereof.

The information acquisition section 10 performs processing of acquiring the external information including information surrounding the device selection control apparatus 1. For example, the information acquisition section 10 has the picture acquisition function of using a camera or the like and a function to receive signal information externally, for example. Here, the external information to be acquired is as follows: information of an image or a picture of the surroundings shot by a camera; and signal information, which is transmitted from candidate devices for control located in the surroundings, such as a sound wave, a light signal emitted by an LED, a beacon or the like, and a wireless signal by an RFIC tag. In this example, the information acquisition section 10 acquires picture information shot by a camera and a light signal emitted by an LED as the external information. Further, the information acquisition section 10 is capable of acquiring, based on the signal information transmitted by the light signal or by the wireless signal, a device identifier (device ID) for identifying the candidate device.

The control section 11 controls various functions that are provided in the device selection control apparatus 1. Specifically, the control section 11 instructs the information acquisition section 10 to acquire the external information when a request for starting a remote operation is informed from the input section 21. Further, by receiving the information (herein after referred to as acquired information) acquired by the information acquisition section 10, and notifying the device detection section 12 and the picture processing section 18, the control section 11 controls a display screen in a normal mode in selecting the target device. Further, the control section 11 switches the normal mode to a device selection mode when notified of shift to the device selection mode from the determination section 16, and controls the display screen in the device selection mode. Still further, the control section 11 receives confirmation of a selection from the input section 21, confirms the currently focused candidate device as the target device, and informs the output section 22 of an operation request.

The device detection section 12 receives, via the control section 11, the acquired information acquired by the information acquisition section 10, and detects candidate devices located around the device selection control apparatus 1. Further, the device detection section 12 acquires information related to the detected candidate devices (for example, position information representing the position of the candidate device, or shape information representing the size or the like of the device), and notifies the device center position detection section 14. At this time, the device detection section 12 may acquire, as the acquired information, the position information or the shape information together with the device ID that identifies the candidate device, or may acquire the shape information or the like stored in the device information database 13 included in the device selection control apparatus 1 by using the device ID included in the acquired information. Further, the device detection section 12 may acquire coordinate information (i.e., position information) or the shape information of each of the devices on the real-time display screen displaying the picture information, based on the picture information shot by the camera, a light emitting position of the LED, and the like. Further, the device detection section 12 may externally acquire the shape information and the like via a network based on the acquired device ID.

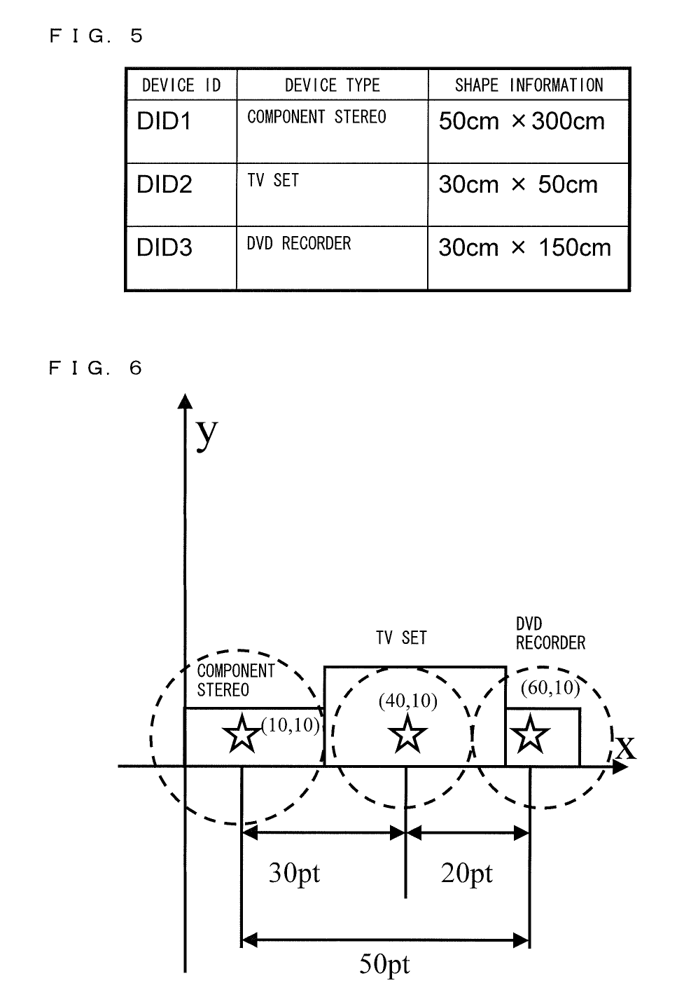

The device information database 13 (see FIG. 5) stores device information related to the candidate devices. The device information includes, for example, a device ID identifying the candidate device, device types representing the type of the candidate device, shape information representing the size and the shape of the candidate device, and the like. The details will be described later with reference to FIG. 5.

The device center position detection section 14 detects the center position of the candidate device detected by the device detection section 12 by using the notified position information, and notifies the determination section 16 of the detected center position. The device center position detection section 14 can detect the center position of the candidate device based on the picture information shot by the camera, a light emitting position of the LED, and the like.

Further, when detecting the candidate devices initially, the device center position detection section 14 calculates, as initial processing, an inter-device distance, an initial center position, and an allowable shake threshold value so as to be stored in the device information storage section 15. Specifically, the device center position detection section 14 calculates the distance between the candidate devices by using the detected center positions, and stores the calculated distance in the inter-device distance storage section 23 as the inter-device distance. Further, the device center position detection section 14 stores the detected center position in the device center position storage section 24 as the initial center position. In addition, for the candidate device, the device center position detection section 14 sets a predetermined distance as an allowable shake threshold value so as to be stored in the allowable shake threshold value storage section 25.

When there are a plurality of candidate devices, for example, the device center position detection section 14 sets half a minimum distance among respective distances between one candidate device and others as the allowable shake threshold value. The device center position detection section 14 may set the allowable shake threshold value to a different value such as one third or one fourth of the minimum inter-device distance.

The determination section 16 compares the real-time center position information of the candidate device, received from the device center position detection section 14, with the initial center position thereof stored in the device center position storage section 24. Then, the determination section 16 calculates the shake amount of the candidate device, and determines whether or not the calculated shake value exceeds the allowable shake threshold value by using the allowable shake threshold value stored in the allowable shake threshold value storage section 25. As a result of the determination, the determination section 16 determines shift to the device selection mode at a moment when the calculated shake value exceeds the allowable shake threshold value, and notifies the control section 11.

The state information storage section 17 stores a current processing mode (normal mode or device selection mode) and information (device ID, for example) for identifying the currently focused candidate device.

The picture processing section 18 processes picture information to be displayed on the display section 20. In addition, when the processing mode stored in the state information storage section 17 is the device selection mode, the picture processing section 18 performs zoom processing on the picture information received from the control section 11.

The display data generation section 19 receives the picture information processed by the picture processing section 18, generates display data by superimposing a focus indication mark on the picture information, and outputs the generated display data to the display section 20. Specifically, the focus indication mark is displayed in a manner that is superimposed on a specified device in the picture information, the specified device being the currently focused candidate device stored in the state information storage section 17. In addition, when the processing mode stored in the state information storage section 17 is the device selection mode, the zoom processing is performed on the generated display data so as to place the currently focused candidate device at the center of the display.

The display section 20 is a display device such as an LCD (Liquid Crystal Display), and outputs on the display the display data generated by the display data generation section 19.

The input section 21 receives a user's input operation using an input device such as a key or a touch panel, an instruction generated by an application running on the device selection control apparatus 1 and the like, and notifies the control section 11 of a request for starting the remote operation and of confirmation of the selection of the target device.

The output section 22 receives the request for the operation from the control section 11, generates a signal for the remote operation of the confirmed target device, and outputs the generated signal for the operation.

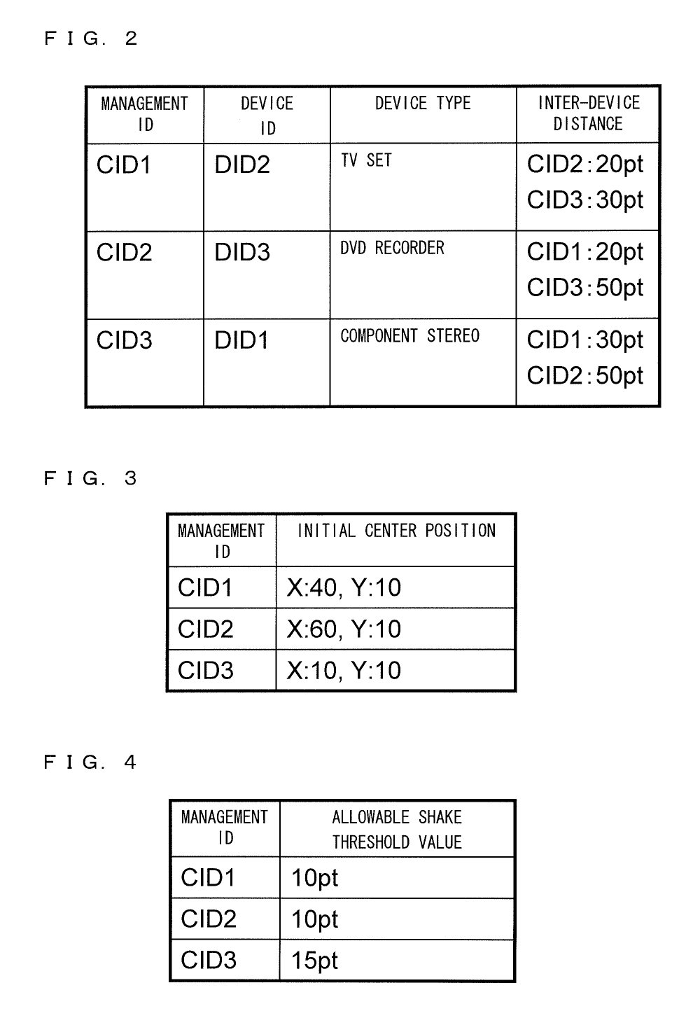

Next, data used by the device selection control apparatus 1 will be described in detail. FIG. 2 illustrates an example of data stored in the inter-device distance storage section 23. In FIG. 2, the inter-device distance storage section 23 stores a distance (i.e., inter-device distance) between plural candidate devices detected by the device detection section 12. In this example, the inter-device distance storage section 23 stores a management ID, a device ID, a device type, and the inter-device distance for each candidate device.

The management ID is an ID for managing the candidate device detected, in initial processing, by the device detection section 12. The device ID is identification data for identifying the candidate device, and assigned at the time of product shipment, for example. The device ID may be included in the acquired information acquired by the information acquisition section 10, or may be obtained from the device information database 13. The device type represents the type of the target device. In this example, the device type represents that the target devices are a TV set, a DVD recorder, and a component stereo. The device type may be included in the acquired information acquired by the information acquisition section 10, or may be obtained from the device information database 13. A pixel or the like that serves as a distance unit on the display may be used as a unit for the inter-device distance.

FIG. 3 illustrates an example of data stored in the device center position storage section 24. In FIG. 3, the device center position storage section 24 stores the center position (i.e., the initial center position) at initial processing of the candidate device. In this example, the device center position storage section 24 stores the management ID and the initial center position for each candidate device. The initial center position is represented by coordinates (X-coordinate, Y-coordinate) on the display where the bottom left corner of the display is defined as a reference point (0, 0) of the coordinate. In addition, the device center position storage section 24 may store the device ID instead of the management ID.

FIG. 4 illustrates an example of data stored in the allowable shake threshold value storage section 25. In FIG. 4, the allowable shake threshold value storage section 25 stores the allowable shake threshold value for shake from the initial center position of the candidate device, for determining the timing of shifting from the normal mode to the device selection mode. In this example, the allowable shake threshold value storage section 25 stores the management ID and the allowable shake threshold value for each candidate device. Here, half the minimum distance among respective distances between one candidate device and others is set as the allowable shake threshold value. The pixel or the like that serves as the distance unit on the display may be used as the unit of the allowable shake threshold value. Further, though the allowable shake threshold value storage section 25 stores the management ID, the allowable shake threshold value storage section 25 may store the device ID instead of the management ID.

In addition, though, in the present embodiment the, device information storage section 15 stores three different tables, each in the inter-device distance storage section 23, in the device center position storage section 24, and in the allowable shake threshold value storage section 25, the device information storage section 15 may store the three tables together in one table, or may manage the information in a format other than a table.

FIG. 5 illustrates an example of the device information stored in the device information database 13. In FIG. 5, the device information database 13 stores the device information related to a potential candidate device. In this example, the device information database 13 stores the device ID, the device type, and the shape information representing the size and the shape of the device for each potential candidate device. The display data generation section 19 can change the size of the focus indication mark by using the shape information. For example, when the currently focused candidate device is large in size, the display data generation section 19 can accordingly increase the size of the focus indication mark. The device information stored in the device information database 13 may be assigned at the time of product shipment, may be assigned by a user, or may be obtained via a network.

FIG. 6 illustrates an exemplary layout of the candidate devices respectively corresponding to exemplary set values shown in FIGS. 2-4. In FIG. 6, star shapes indicate the initial center positions of the candidate devices, and the inter-device distance is determined by using the initial center positions. For example, the inter-device distance of the TV set and the component stereo measures 30 pt, the inter-device distance of the TV set and the DVD recorder measures 20 pt, and the inter-device distance of the component stereo and the DVD recorder measures 50 pt. In addition, circles indicated by dashed lines each represents a range of an allowable shake threshold value for shake from the initial center position of each candidate device. For example, a radius (allowable shake threshold value) of a circle centering on the TV set is set to 10 pt that is half the minimum inter-device distance 20 pt among the inter-device distance 30 pt between the TV set and the component stereo, and the inter-device distance 20 pt between the TV set and the DVD recorder.

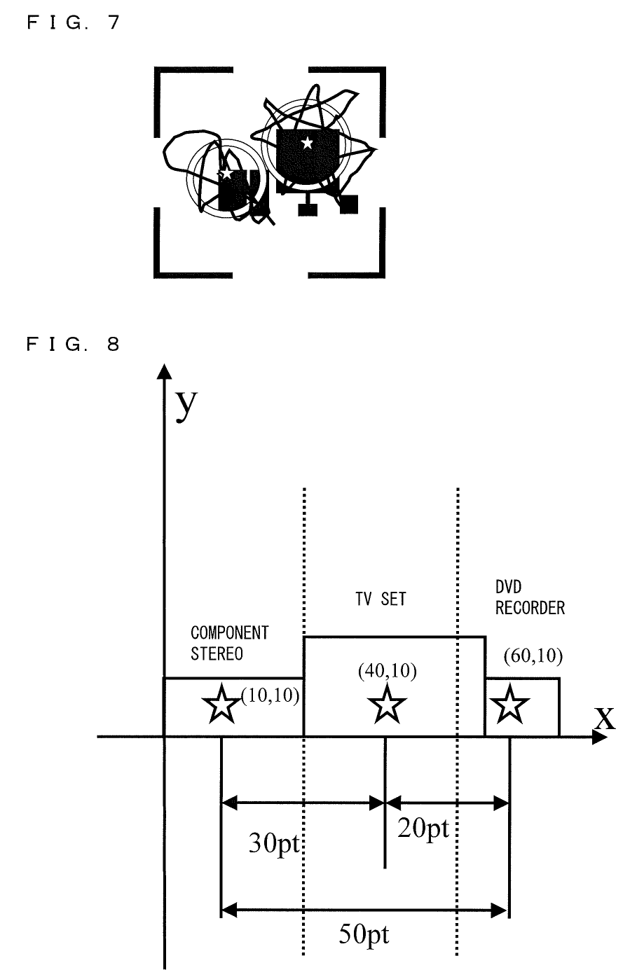

FIG. 7 is a diagram illustrating a processing image when the determination section 16 determines the respective shake amounts of latest center positions of the candidate devices. In FIG. 7, the initial center position of each of the candidate devices is indicated by a star shape, and a circle centering on the initial center position indicates a set of dots, each dot being at a distance of the allowable shake threshold value. The determination section 16 determines that the shake amount of each candidate device exceeds the allowable shake threshold value at a moment when the latest center position of the candidate device goes beyond the circle. In addition, the allowable shake threshold value becomes larger with increasing inter-device distance, so that the circle illustrated here also increases.

That is, it is easy for a user to select a candidate device when the inter-device distance in a displayed picture is large. On the contrary, it is difficult to select the specific target device when the inter-device distance is small because the candidate devices are densely located, or when the candidate devices are located far from a user. This is because the picture is shaken to a larger degree due to hand movement or an operation on a zoomed image, for example, so that the center position of the candidate device is hard to be fixed. For this reason, the device selection control apparatus 1 shifts to the device selection mode based on determination that the density of the candidate devices is high when the shake amount of the candidate device exceeds the allowable shake threshold value.

The device selection control apparatus 1 may change to the device selection mode based on determination that the density of the candidate devices is high when the latest center position of the candidate device goes beyond a straight line which is drawn at a distance of the allowable shake threshold value from the initial center position in an X-axis direction and which is in parallel with a Y-axis, as illustrated in FIG. 8.

Further, the device selection control apparatus 1 may determine to shift to the device selection mode based on determination that the density of the candidate devices is high when the number of candidate devices in the picture information exceeds a predetermined number. Alternatively, the device selection control apparatus 1 may determine to shift to the device selection mode based on determination that the density of the candidate devices is high when the number of candidate devices within a specified range in the picture information exceeds a predetermined number.

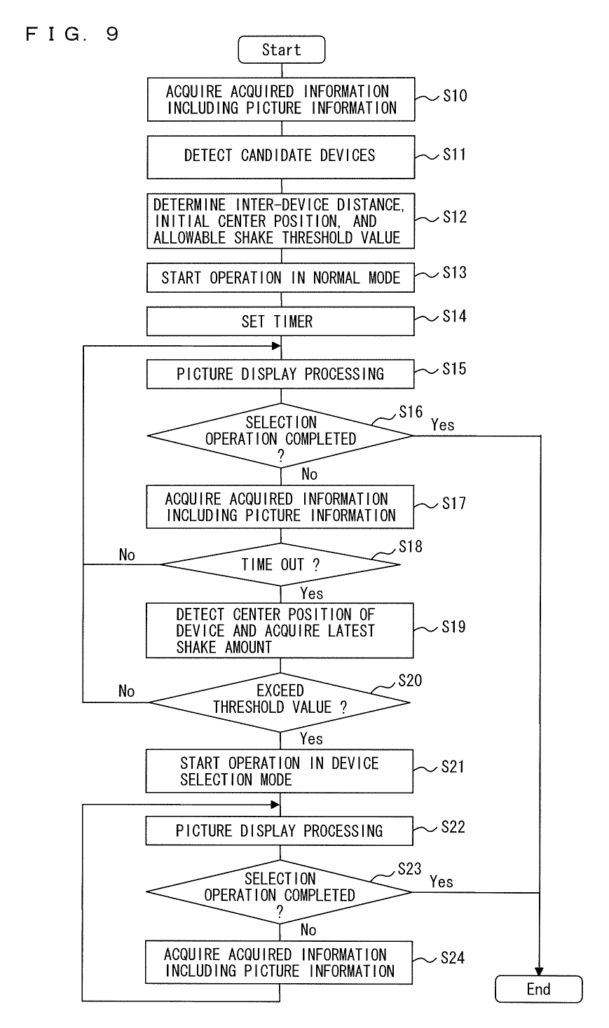

Next, an operation of the device selection control apparatus 1 to select the target device to be remotely operated will be described with reference to FIG. 9. Initially, the control section 11 starts an operation when a request for starting the remote operation is notified from the input section 21 by a user's input operation or the like. The control section 11 instructs the information acquisition section 10 to acquire the external information, receives the acquired information from the information acquisition section 10, and notifies the device detection section 12 of the acquired information having been received (step S10). Here, the acquired information is information including picture information shot by the camera, a light signal by an LED, and the like. In addition, the acquired information may be a combination of the above information. Here, as an example of the acquired information, the picture information shot by the camera and the light signal by the LED will be described. The control section 11 can detect that in which direction or at which position the candidate device is located by receiving the directional light signal by the LED or the like.

Next, the device detection section 12 receives, via the control section 11, the acquired information acquired by the information acquisition section 10, and detects the candidate devices located in the surroundings (step S11). Further, the device detection section 12 acquires the position information representing the position of the detected candidate device and the shape information representing the size, the shape, and the like of the device, and notifies the device center position detection section 14. In addition, the device detection section 12 may acquire the device ID, the position information, the shape information, and the like from the acquired information having being received, or may inquire of the device information database 13 about the shape information and the like based on the device ID included in the acquired information. Further, the device detection section 12 may newly acquire the shape information and the like through a network.

As initial processing, the device center position detection section 14 calculates the inter-device distance, the initial center position, and the allowable shake threshold value information by using the notified position information for all of the candidate devices detected by the device detection section 12, and stores the calculated information in the device information storage section 15 (step S12). Specifically, for each of the candidate devices detected by the device detection section 12, the device center position detection section 14 detects the center position of each of the candidate devices by using the notified position information, calculates the inter-device distance by using the detected center positions, and stores the calculated information in the inter-device distance storage section 23. Further, the device center position detection section 14 stores the detected center position in the device center position storage section 24 as the initial center position. Further, the device center position detection section 14 sets a predetermined distance as the allowable shake threshold value for each of the candidate devices, and stores the allowable shake threshold value in the allowable shake threshold value storage section 25.

As initial processing, the device center position detection section 14 notifies the determination section 16 of the detected center position after storing the inter-device distance, the initial center position, and the allowable shake threshold value information. When the center position is notified, the determination section 16 notifies the control section 11 of a start of the normal mode operation. The control section 11 sets the current processing mode, stored in the state information storage section 17, to the normal mode. Accordingly, the operation in the normal mode starts (step S13).

The control section 11 sets a timer for determining a shake (step S14), and outputs, to the picture processing section 18, real-time picture information notified from the information acquisition section 10. The picture processing section 18 does not perform the zoom processing because the processing mode stored in a state information storage section 17 is the normal mode, and notifies the display data generation section 19 of the picture information. The display data generation section 19 generates display data by superimposing a focus indication mark on the received picture information, and outputs the generated display data to the display section 20 (step S15). At this time, since a specific devise is not set as the currently focused candidate device in the state information storage section 17, the focus indication mark is displayed so as to be superimposed at the center of the display.

When selection operation completion notice is received from the input section 21 (Yes in step S16), the control section 11 determines the selected candidate device as the target device, and terminates the processing. On the other hand, when the selection operation completion notice is not received from the input section 21 (No in step S16), the control section 11 receives, from the information acquisition section 10, the acquired information including the real-time picture information (step S17), and performs processing from step S15 to step S18 repeatedly (No in step S18) until the set timer time outs. Accordingly, the real-time picture information is displayed on a display of the display section 20.

When the set timer time outs (Yes in step S18), the control section 11 notifies the device detection section 12 of the acquired information received from the information acquisition section 10. The device detection section 12 acquires the latest position information of the candidate devices and notifies the device center position detection section 14. The device center position detection section 14 detects the latest center positions of the candidate devices by using the notified position information, and notifies the determination section 16. The determination section 16 acquires a shake amount of each of the candidate devices, on the picture, from the initial center position by using the latest center position notified from the device center position detection section 14 and the initial center position stored in the device center position storage section 24 (step S19). The determination section 16 compares the acquired shake amount with the allowable shake threshold value stored in the allowable shake threshold value storage section 25, and determines whether or not the shake amount exceeds the allowable shake threshold value (step S20).

When the shake amount does not exceed the allowable shake threshold value (No in step S20), the processing proceeds to step S16, and processing in the normal mode is repeatedly performed. On the other hand, when the shake amount exceeds the allowable shake threshold value (Yes in step S20), the determination section 16 determines shift from the normal mode to the device selection mode, and notifies the control section 11. The control section 11 sets the current processing mode stored in the state information storage section 17 to the device selection mode, and sets the management ID of a device currently existing at the center of the display as the currently focused candidate device (step S21). Accordingly, at a moment when the shake amount exceeds the allowable shake threshold value, it is possible to switch the normal mode to the device selection mode.

The control section 11 outputs, to the picture processing section 18, the real-time picture information notified from the information acquisition section 10. The picture processing section 18 performs the zoom processing because the processing mode stored in the state information storage section 17 is the device selection mode, and notifies the display data generation section 19 of the picture information after the zoom processing. The display data generation section 19 generates the display data by superimposing the focus indication mark on the picture information after the zoom processing received from the picture processing section 18, and outputs the generated display data to the display section 20 (step S22). At this time, the focus indication mark is displayed so as to be superimposed on the specific device in the picture information, the device being the currently focused candidate device stored in the state information storage section 17. Further, since the processing mode stored in the state information storage section 17 is the device selection mode, the generated display data has been subjected to zoom processing so as to cause the currently focused candidate device to be located at the center of the display.

When the selection operation completion notice is received from the input section 21 (Yes in step S23), the control section 11 determines the currently focused candidate device as the target device, and terminates the processing. On the other hand, when the selection operation completion notice is not received from the input section 21 (No in step S23), the control section 11 receives, from the information acquisition section 10, the acquired information including the real-time picture information (step S24), advances the processing to step S22, and performs processing in the device selection mode repeatedly.

As described above, the device selection control apparatus 1 can switch the normal mode to the device selection mode at a moment when the shake amount of the candidate device exceeds the allowable shake threshold value.

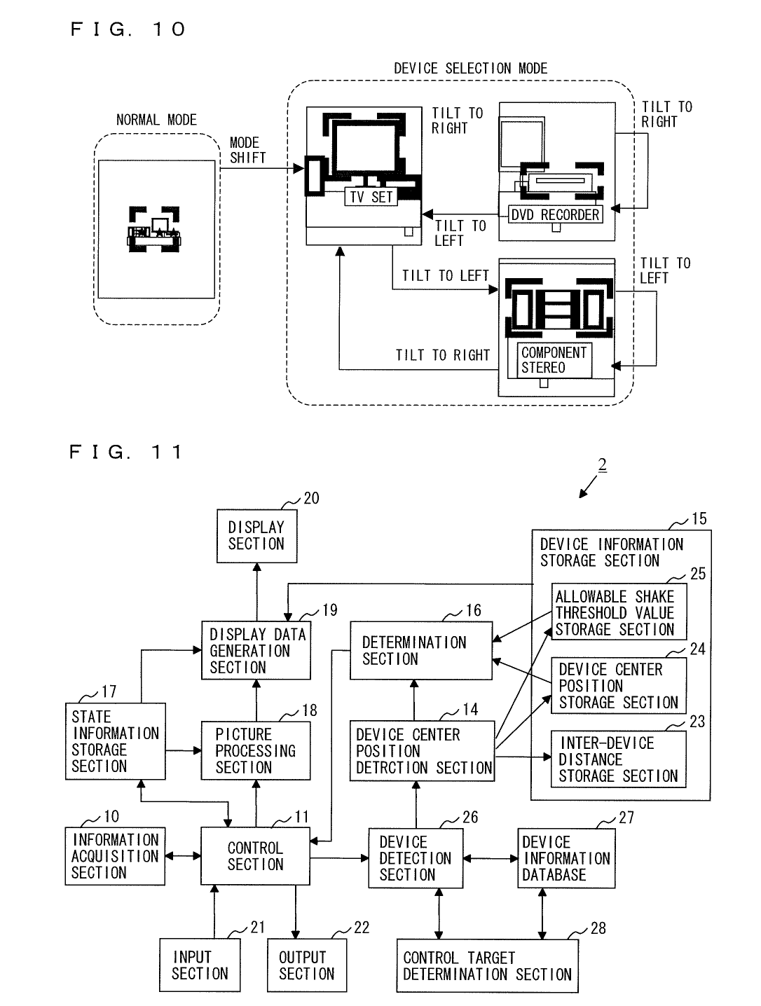

FIG. 10 illustrates a display image on the display when the specific target device is selected from among a plurality of candidate devices. As seen from FIG. 10, the device selection control apparatus 1 displays the focus indication mark so as to be superimposed at the center of the display during the operation in the normal mode. Here described is an example where the plurality of candidate devices are displayed in a focus frame because the candidate devices are densely located, and the normal mode is shifted to the device selection mode when the shake amount exceeds the allowable shake threshold value during the operation in the normal mode.

During the operation in the device selection mode, the device selection control apparatus 1 displays the picture information by zooming so as to locate one currently focused candidate device at the center of the display. Here described is an example where the shape of the focus indication mark is changed depending on the size of the candidate device. In addition, as a user's operation, when a user performs an operation to cause a right side to be displayed (such as tilting or swinging the device selection control apparatus 1 to the right, or pressing a right cursor key), the device selection control apparatus 1 may display a device, which is on the right side of a currently displayed candidate device, at the center of the display. Similarly, when a user performs an operation to cause a left side to be displayed (such as tilting or swinging the device selection control apparatus 1 to the left, or pressing a left cursor key), the device selection control apparatus 1 may display a device, which is on the left side of a currently displayed candidate device, at the center of the display. Further, when a device at the right extremity is displayed and a user tries to select a device on the further right, the device selection control apparatus 1 may perform processing of canceling the device selection mode and shifting to the normal mode.

As described above, when selecting the specific target device from among the plurality of candidate devices, the device selection control apparatus 1 according to the first embodiment of the present invention receives, as the acquired information, the picture information of surroundings shot by a camera and the light signal emitted from the candidate devices located in the surroundings. Then, as initial processing, the device selection control apparatus 1 determines, based on the received acquired information, and stores the center position and the allowable shake threshold value of the candidate device. Then, the device selection control apparatus 1 determines a real-time shake amount of the candidate device by using the acquired information continuously receiving during the selection operation performed by the user. When the shake amount exceeds the allowable shake threshold value, the device selection control apparatus 1 determines that the plurality of candidate devices are located far away or densely located, and shifts to the device selection mode to continue the selection operation. Accordingly, when selecting the specific target device from among the plurality of candidate devices, the device selection control apparatus 1 can control the timing of performing the zoom processing, based on the shake amount of the candidate device whose picture is being shot in real time. Accordingly, errors in the operation when selecting the specific target device can be reduced.

In addition, the device selection control apparatus 1 may display, during the zoom processing on the picture information in the device selection mode, an image by zooming at some moment after the selection operation is started, or may display the picture information actually processed by the zoom processing using a shake compensation technique. However, the picture information is not displayed exactly in accordance with an actual motion of the user, but the picture information generated by compensation, for example, is displayed in a manner that the candidate device has moved half the distance that the candidate device has actually moved on the picture information, for example.

Further, the device selection control apparatus 1, during the operation in the device selection mode, may scroll the displayed picture information in accordance with a moving distance and a moving direction of the camera caused by the user's operation, and shift the focus to a next candidate device for selection, when the next candidate device for selection is displayed on the display. Further, the display may be switched to display picture information of the next candidate device for selection at the center of the display anytime.

In addition, in the above-described embodiment, when the control section 11 receives from the input section 21, depending on a user's input operation or the like, the request for starting the remote operation and starts to acquire the external information, the processing proceeds to step S11 and thereafter. However, the processing may proceed to step S11 and thereafter when there is no change in the position or the orientation of the device selection control apparatus 1 for a certain period of time while the information acquisition section 10 continues to acquire the external information.

In addition, in the above-described embodiment, an example is described where the device center position detection section 14 is notified of the information (position information and shape information) related to the candidate device detected by the device detection section 12, and the device center position detection section 14 calculates the inter-device distance, the initial center position, and the allowable shake threshold value, and stores the calculated information in the device information storage section 15. However, the device detection section 12 may calculate the inter-device distance, the initial center position, and the allowable shake threshold value, and store the calculated information in the device information storage section 15.

In addition, although the device selection control apparatus 1 determines to shift either to the normal mode or to the device selection mode based on the shake amount from the initial center position, the device selection control apparatus 1 may determine not to shift to the device selection mode when the shake amount falls within a range occupied by a shape of the device even though the shake amount exceeds the allowable shake threshold value.

### Second Embodiment

FIG. 11 is a block diagram illustrating an exemplary configuration of a device selection control apparatus 2 according to a second embodiment of the present invention. In FIG. 11, in comparison with the device selection control apparatus 1 according to the first embodiment, the device selection control apparatus 2 differs in an operation of a device detection section 26 and device information stored in a device information database 27. In addition, the device selection control apparatus 2 further includes a control target determination section 28. In FIG. 11, as to the components similar to those of the device selection control apparatus 1 according to the first embodiment are denoted by the same reference numeral, and description thereof will be omitted.

In FIG. 11, it is similar to the first embodiment that the device detection section 26 receives, via the control section 11, the acquired information acquired by the information acquisition section 10, and detects the candidate devices located around the device selection control apparatus 2. However, the device detection section 26 inquires of the control target determination section 28, and informs the device center position detection section 14 of only information related to a device to be actually treated as the candidate device. At this time, the device detection section 26 may acquire, as the acquired information, collaboration information together with the device ID of the candidate device, or may acquire the collaboration information stored in the device information database 27 by using the device ID included in the acquired information.

Here, in the case where there is a device (collaboration target device) to perform a collaborative operation with a candidate device, the collaboration information is the information that specifies the collaboration target device. Typically, the collaboration information means the device ID of the collaboration target device. Further, when a candidate device is operated, the collaborative operation means that another device collaborating therewith is also operable, for example. Still further, the device detection section 12 may acquire real-time position information and shape information of the candidate device on a display screen that displays the picture information, based on the picture information shot by the camera, the position where the LED emits light, and the like. Still further, the device detection section 12 may externally acquire, based on the acquired device ID, the shape information, and the like via a network.

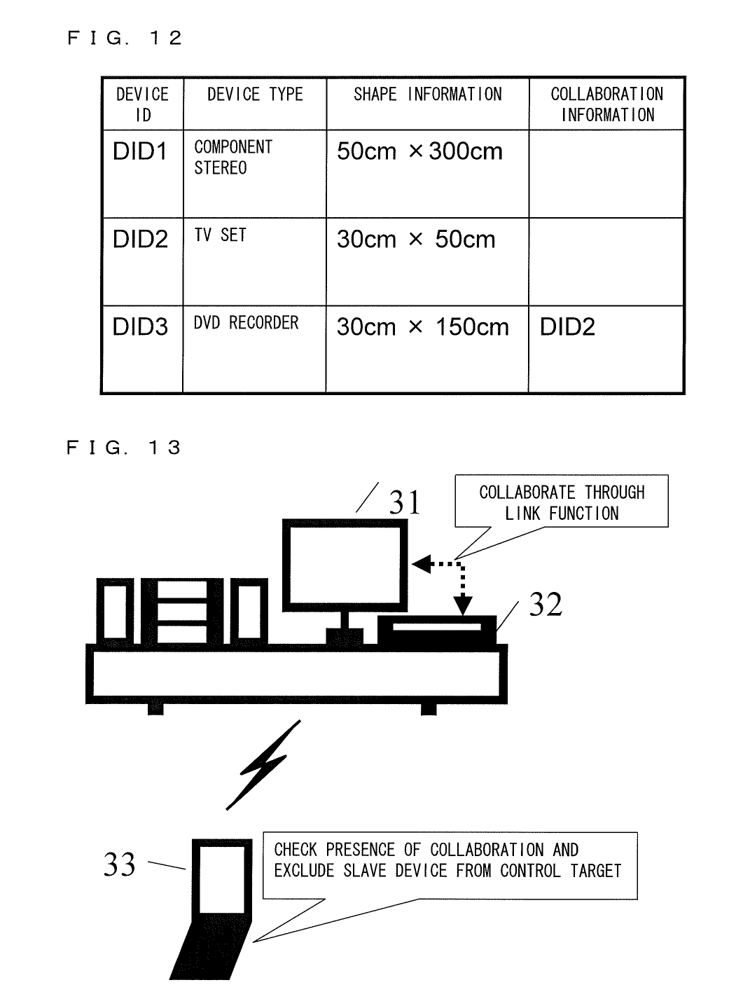

The device information database 27 (see FIG. 12) stores device information related to a potential candidate device. The device information includes collaboration information in addition to the device ID, the device type, and the shape information.

FIG. 12 illustrates an example of the device information stored in the device information database 27. In FIG. 12, the device information database 27 stores the device information related to the potential candidate device. In the example, the device information includes the collaboration information in addition to the device ID, the device type, and the shape information. In the case where there is another device (collaboration target device) to perform the collaborative operation with the candidate device, the device ID of the collaboration target device is set as the collaboration information. Here, an example is illustrated where a DVD recorder (DID3) collaborates with a TV set (DID2), and the TV set (DID2) is set as the collaboration information of a slave device (DVD recorder).

The control target determination section 28 determines the device to be actually treated as the candidate device in response to the inquiry from the device detection section 26. Specifically, the control target determination section 28 recognizes master-slave relationship between collaborative functions, and excludes a slave device from the selection target. In addition, the control target determination section 28 may determine the device to be excluded from the selection by preliminarily registering a specific device in the device information database 27 as a device out of the selection.

Next, a specific operation of the device selection control apparatus 2 is described with reference to FIG. 13 in the case where a TV set 31 and a DVD recorder 32 collaborate with each other by a link function between devices. In this case, the device selection control apparatus 2 is notified of the collaboration information from the TV set 31 indicating collaboration with the DVD recorder 32, and is notified of the collaboration information from the DVD recorder 32 indicating collaboration with the TV set 31. In the device selection control apparatus 2, the device detection section 12 detects the notified collaboration information, and notifies the device detection section 26. The device detection section 26 recognizes master-slave relationship between the collaborative devices, and excludes a slave device (DVD recorder 32 in the present example) from the selection target. In this manner, by excluding the slave device from the selection target, the number of the candidate devices for selection is reduced, so that a user's selection operation can be facilitated. Though it is described that both of the TV SET 31 and the DVD recorder 32 transmit the collaboration information, only either one may transmit the collaboration information.

When the collaboration information indicating the collaboration with the TV set 31 is notified from the DVD recorder 32, the device detection section 12 stores the notified collaboration information in the device information database 13. In the present example, the indication that the DVD recorder 32 collaborates with the TV set 31 is recorded as the collaboration information from the DVD recorder 32, and the slave DVD recorder 32 is excluded from the selection target.

In this manner, the device selection control apparatus 2 recognizes the slave device, and excludes the slave device from selection, whereby the number of devices displayed as the candidate device for selection is reduced, and also the allowable shake threshold value increases. Accordingly, operation errors in selecting the specific target device from among the plurality of candidate devices can be reduced.

As described above, when selecting the specific target device from among the plurality of candidate devices, the device selection control apparatus 2 according to the second embodiment of the present invention receives, as the acquired information, the picture information of the surroundings shot by the camera, the light signal emitted from the candidate devices located in the surroundings, and excludes the slave candidate device from selection based on the received acquired information. Then, the center positions and the allowable shake threshold values of the remaining candidate devices are determined and stored as initial processing. Then, the real-time shake amount of the candidate device is determined by using the acquired information continuously received during the user's selection operation, and when the shake amount exceeds the allowable shake threshold value, it is determined that the plurality of candidate devices are located far away or densely located, and the selection operation is continued after shifting to the device selection mode. Accordingly, when selecting a specific target device from among a plurality of candidate devices, the device selection control apparatus 1 can control timing of the zoom processing, after excluding the slave candidate device, based on the shake amount of the candidate device whose picture is shot in real time. Accordingly, errors in the operation when selecting the specific target device can be reduced.

Further, process procedures performed by the respective device selection control apparatuses described in the above-described respective embodiments of the present invention may be realized by a CPU interpreting and executing predetermined program data capable of executing the above-described process procedures stored on a storage device (a ROM, a RAM, a hard disc, and the like). In this case, the program data may be introduced into the storage device via a storage medium, or may be directly executed on the storage medium. Here, the storage medium includes: a semiconductor memory such as a ROM, a RAM, a flash memory, and the like; a magnetic disc memory such as a flexible disc, a hard disc, and the like; an optical disc memory such as a CD-ROM, a DVD, a BD, and the like; and a memory card and the like. Further, the storage medium is a notion including a communication medium such as a phone line, a carrier path, and the like.

Further, each of the respective components (e.g., information acquisition section 10, device detection section 12, device center position detection section 14, device center position storage section 24, allowable shake threshold value storage section 25, determination section 16, picture processing section 18, display data generation section 19, and the like) included in the device selection control apparatuses according to the above-described respective first and second embodiments is executed as an LSI, an integrated circuit. The components may be each provided in a chip form, or some or all of the function blocks may be provided in a chip form. The LSI may be referred to as an IC, a system LSI, a super LSI, an ultra LSI depending on the degree of integration.

Further, the method of integration is not limited to the LSI, and may be realized by a dedicated circuit or a general purpose processor. Alternatively, an FPGA (Field Programmable Gate Array) which is programmable after manufacturing the LSI, or a reconfigurable processor enabling reconfiguration of connection or setting of a circuit cell in the LSI may be used. Still alternatively, a configuration may be used in which, a hardware resource includes a processor, a memory, and the like, and the processor executes and controls a control program stored in a ROM. Still further, in the case where another integration technology replacing the LSI becomes available due to an improvement of a semiconductor technology or due to emergence of another technology derived therefrom, the function blocks may be integrated using such a new technology. For example, biotechnology may be applied.

### INDUSTRIAL APPLICABILITY

The device selection control apparatus according to the present invention has a function, in the case where a plurality of candidate devices are located far away or densely located, to control the timing of performing the zoom processing based on the density of the candidate devices, and is applicable to a remote control devices for remote-controlling the plurality of candidate devices. Further, the device selection control apparatus according to the present invention can be also applicable to a mobile device or the like which is connectable to a network, such as a mobile telephone or a personal digital assistance.

1. A device selection control apparatus for selecting a specific target device for control from among a plurality of candidate devices for control, the device selection control apparatus comprising:
an information acquisition section that acquires information including picture information which is obtained by shooting a picture of the candidate devices, and a device identifier which identifies each of the candidate devices;
a device detection section that detects at least one candidate device based on the information that has been acquired by the information acquisition section;
a device center position detection section that detects position information of the candidate device detected by the device detection section, and sets, based on the position information initially detected, an allowable shake threshold value of the candidate device;
a device center position storage section that stores the position information initially detected by the device center position detection section;
an allowable shake threshold value storage section that stores the allowable shake threshold value set by the device center position detection section;
a determination section that acquires a shake amount of the candidate device by using latest position information received from the center position detection section and the position information initially detected and stored in the device center position storage section, and determines to switch to zoom processing on the picture information when the shake amount exceeds the allowable shake threshold value;
a picture processing section that performs the zoom processing on the picture information when the determination section determines to switch to the zoom processing; and
a display data generation section that acquires the picture information from the picture processing section, and generates display data.

2. The device selection control apparatus according to claim 1, wherein when distances between a specific candidate device and other candidate devices among the plurality of candidate devices are defined as inter-device distances, the device center position detection section selects a minimum inter-device distance from the inter-device distances, and sets half the minimum inter-device distance as the allowable shake threshold value of the specific candidate device.

3. The device selection control apparatus according to claim 1, further comprising
a device information database that stores device information including a device identifier capable of identifying the candidate device, wherein
the device detection section acquires the device information stored in the device information database by using the device identifier acquired from the information acquisition section, and specifies a position of the candidate device.

4. The device selection control apparatus according to claim 1, wherein when detecting that the shake amount exceeds the allowable shake threshold value a predetermined number of times, the determination section determines to switch to the zoom processing on the picture information.

5. The device selection control apparatus according to claim 1, further comprising a control target determination section that excludes, based on collaboration information that specifies a device performing a collaborative operation with the candidate device, a slave candidate device from the candidate devices detected by the device detection section.

6. The device selection control apparatus according to claim 5, wherein
the collaboration information is included in the information acquired by the information acquisition section, and
the control target determination section acquires the collaboration information from the information acquisition section via the information detection section.

7. The device selection control apparatus according to claim 5, wherein
the collaboration information is included in the device information stored in the device information database, and
the control target determination section acquires the collaboration information from the device information database.

8. An integrated circuit used for a device selection control apparatus which selects a specific target device for control from among a plurality of candidate devices for control, the integrated circuit comprising:
an information acquisition section that acquires information including picture information which is obtained by shooting a picture of the candidate devices and a device identifier which identifies each of the candidate devices;
a device detection section that detects at least one candidate device based on the information that has been acquired by the information acquisition section;
a device center position detection section that detects position information of the candidate device detected by the device detection section and sets, based on the position information initially detected, an allowable shake threshold value of the candidate device;
a device center position storage section that stores the position information initially detected by the device center position detection section;
an allowable shake threshold value storage section that stores the allowable shake threshold value set by the device center position detection section;
a determination section that acquires a shake amount of the candidate device by using latest position information received from the center position detection section and the initially detected position information stored in the device center position storage section, and determines to switch to zoom processing on the picture information when the shake amount exceeds the allowable shake threshold value;
a picture processing section that performs the zoom processing on the picture information when the determination section determines to switch to the zoom processing; and
a display data generation section that acquires the picture information from the picture processing section, and generates display data.

9. A method for selecting a specific target device for control from among a plurality of candidate devices for control, the method comprising:
an information acquisition step of acquiring information including picture information which is obtained by shooting a picture of the candidate devices and a device identifier which identifies each of the candidate devices;
a device detection step of detecting at least one candidate device based on the information that has been acquired in the information acquisition step;
a device center position detection step of detecting position information of the candidate device detected in the device detection step and setting, based on the position information initially detected, an allowable shake threshold value of the candidate device;
a determination step of acquiring a shake amount of the candidate device by using latest position information received from the center position detection step and the position information initially detected in the device center position storage step, and determining to switch to zoom processing on the picture information when the shake amount exceeds the allowable shake threshold value;
a picture processing step of performing the zoom processing on the picture information when the determination step determines to switch to the zoom processing; and
a display data generation step of acquiring the picture information from the picture processing step, and generating display data.
